(19) United States
(12) Patent Application Publication
(10) Pub. No.: US 2002/0111818 A1
(43) Pub. Date: Aug. 15, 2002

(54) Method and apparatus for providing independent filtering of e-commerce transactions

(75) Inventors: John F. Morar, Mahopac, NY (US); David M. Chess, Mohegan Lake, NY (US); Aaron Kershenbaum, New City, NY (US); Edward J. Pring, Putnam Valley, NY (US); Ian N. Whalley, Pawling, NY (US); Steve R. White, New York, NY (US)

Correspondence Address: HARRINGTON & SMITH, LLP, 1809 BLACK ROCK TURNPIKE, FAIRFIELD, CT, 06432, US

(73) Assignee: International Business Machines Corporation, Armonk, NY (US)

(21) Appl. No.: 09/783,897

(22) Filed: Feb. 15, 2001

(51) Int. Cl. G06F 17/60

(52) U.S. Cl. 705/1; 705/44

(57) ABSTRACT

A method for operating a data communication system comprises the steps of (a) originating an electronic commerce transaction at a first party, (b) transmitting the electronic commerce transaction through the data communications network towards a second party, (c) during the step of transmitting, inputting the electronic commerce transaction to an electronic commerce transaction filter that is interposed between two network components, and (e) operating the electronic commerce transaction filter to take some action with respect to the electronic commerce transaction.

FIELD OF THE INVENTION

This invention relates generally to data communication networks and systems and, more particularly, relates to methods and apparatus for performing, monitoring and recording electronic commerce (e-commerce) transactions, such as e-commerce transactions that are transferred between buyers and sellers on the Internet.

### BACKGROUND OF THE INVENTION

A network administrator must typically support many different software products in a networked environment. This is particularly true for applications that perform e-commerce transactions. Products that perform e-commerce transactions typically have their own administrative controls, if they have any administrative controls at all.

E-commerce programs typically have a policy for allowing transactions to proceed to completion. This policy may either be static or hardwired into the system, or it may be dynamic in that it can be updated without redeploying the application. In either case, the policies should be compatible with the deployed e-commerce system that they are associated with. There may, however, be transactions that are allowed by the system, even though the system operator/owner may not approve.

As such, a need exists to make available an add-on policy system that can monitor e-commerce transactions and enforce policy simultaneously for multiple software products and across different e-commerce systems. However, simply attempting to interpose a new policy component between existing system components would most likely fail, as interposing the new policy component requires detailed knowledge of the interface specification between the components at the point of insertion.

The industry is currently moving towards the adoption of publicly available standards for the interaction between the major software components involved in e-commerce transactions. The trend in the industry now and in the expected future is for software vendors to provide system components that must work together. Publicly available standards are believed to be the most efficient way to achieve reliable and proper inter-operation between components provided by different vendors.

It is noted that various techniques currently exist to monitor network messages, such as software products and systems that monitor network traffic for the presence of computer viruses, and content filters that examine the body of a message to modify or eliminate certain content, such as objectionable words or viruses. Also, network firewalls typically examine source and destination addresses of messages, and may also enforce a policy regarding access to certain sites, while proxy servers act on behalf of a client and in so doing may modify a message's addressing information. However, prior to this invention the inventors are not aware of any system or network components or subsystems that provide specific filtering of e-commerce transactions in the manner described herein.

### SUMMARY OF THE INVENTION

The foregoing and other problems are overcome by methods and apparatus in accordance with embodiments of this invention. Disclosed herein is a method for operating a data communication system, as is a data communication system that operates in accordance with the method.

The teachings of this invention provide in one aspect a method for enforcing additional constraints, thereby allowing a system owner/operator to extend the functionality of the system without the knowledge or without requiring the assistance of the original system provider. The teachings of this invention provide a technique for blocking or modifying in-progress e-commerce transactions by intercepting, examining and possibly modifying one or more of the network messages that constitute the e-commerce transaction. These teachings thus provide an ability to enforce a uniform policy across different e-commerce systems and programs, an ability to update the policy without redeploying the e-commerce system, and an ability to insert custom or proprietary filters without the knowledge or the participation of the e-commerce vendor. For example, these teachings enable a system operator/owner to enforce a policy such as the usage of a preferred supplier for airline ticket purchases, or to implement a custom approval/audit policy that is consistent across different e-commerce systems.

These teachings also provide an ability to assemble a single view of all of the e-commerce activities within a company or organization, spanning two or more e-commerce systems and programs. For example, the use of these teachings enable administrators or auditors to track the total monetary volume of purchases made by the company or organization, a function that a single e-commerce program could not provide.

These teachings further provide an ability to block certain e-commerce transactions that are not desired to be active on the system, and/or to masquerade the e-commerce transaction so as to hide certain source information from the vendor fulfilling the order. As an example, assume that an employee of a certain company wishes to electronically purchase software that is downloaded electronically. In this case an e-commerce filter could be employed to hide all information regarding the specific employee from the vendor, while permitting the e-commerce transaction to complete.

In addition, the teachings of this invention can provide protection from certain risks that are inherent in the typical e-commerce environment. These include the case where a user may intentionally attempt to perform an e-commerce transaction that is allowed by the e-commerce system, but which may not be approved of by the user's employer. These further include the case where a user may accidentally attempt to perform an e-commerce transaction that is allowed by the e-commerce system, but which the user did not intend. Other cases of interest include those where an unauthorized program attempts to perform an e-commerce transaction under the auspices of a valid user, or where unauthorized users attempt to use the e-commerce system, or where legitimate programs may have undesired behavior that should be blocked.

A method includes steps of originating an electronic commerce transaction at a first party, transmitting the electronic commerce transaction through the data communications network towards a second party, and during the step of transmitting, inputting the electronic commerce transaction through an electronic commerce transaction filter that is interposed between two network components. The filter operates so as to take some action with respect to the electronic commerce transaction. The action taken with respect to the electronic commerce transaction can include an analysis of the electronic commerce transaction for the purpose of collecting information across an administrative domain and/or an analysis of the electronic commerce transaction for the purpose of enforcing a policy for an administrative domain.

The action taken with respect to the electronic commerce transaction can further include one or more of performing a modification of the electronic commerce transaction, performing a redirection of the electronic commerce transaction to a third party, performing an extraction of information from the e-commerce transaction for recording the information for statistical or other purposes, performing a verification of the authenticity of all or a part of the electronic commerce transaction, performing a verification that the electronic commerce transaction is in compliance with a regulation or with some standard, terminating or delaying the electronic commerce transaction, performing an encryption of all or a part of the electronic commerce transaction, followed by sending the encrypted electronic commerce transaction to another destination, generating an alert if an analysis performed by the electronic commerce transaction filter indicates that the electronic commerce transaction may be fraudulent. Alternatively, the action taken with respect to the electronic commerce transaction can be simply passing the electronic commerce transaction through the electronic commerce transaction filter without modification and without recording any information regarding the electronic commerce transaction.

The action taken with respect to the electronic commerce transaction can be selected at least in part by applying predefined rules to the contents of one or more messages that make up the electronic commerce transaction, or by applying predefined rules that are independent of the contents of one or more messages that make up the electronic commerce transaction, or at least in part by applying predefined rules based on at least one of an origin or a destination of the electronic commerce transaction.

The action taken with respect to the electronic commerce transaction can be an encryption of all or a part of the electronic commerce transaction using at least one cryptographic key, and then sending the at least one cryptographic key to another location.

The action taken with respect to the electronic commerce transaction can further be or can further include recording at least one predetermined type of information, accumulating recorded information from a plurality of electronic commerce transactions, and making the accumulated recorded information available to interested parties.

The action taken with respect to the electronic commerce transaction can further be or can further include recording at least one predetermined type of information, accumulating recorded information from a plurality of electronic commerce transactions, and deriving a filtering criterion from the accumulated recorded information for use in the same or in another electronic commerce transaction filter.

The step of operating may be performed in parallel in a plurality of electronic commerce transaction filters that are disposed between two layers of an administrative domain hierarchy. The step of operating can include an initial step of decrypting all or part of the electronic commerce transaction.

In general, the action may be deduced in part or in whole by applying predefined rules to the contents of one or more messages that comprise an e-commerce transaction, or by applying predefined rules that are independent of the contents of any messages that comprise an e-commerce transaction, or by applying predefined rules based entirely on the origin or destination of one or more messages that comprise an e-commerce transaction.

It is assumed for the purposes herein that an e-commerce transaction may include or be implemented with one or more underlying network messages, where the messages may be sent in quick succession during one period of time, or where at least some of the messages are sent at various times over a period of seconds, or minutes, or hours, or even over longer periods of time. The messages that constitute a given e-commerce transaction may all originate from one party, or they may more likely originate from two or more parties that are directly or indirectly involved in the e-commerce transaction. As an example, a first message or set of messages may be from a first party to a second party requesting a catalog. A second message or set of messages may be from the second party to the first party providing the requested catalog. A third message or set of messages may be from the first party to the second party inquiring concerning the price and availability of an item in the catalog, and a fourth message or set of messages may be from the second party to the first party responding to the inquiry. Messages or sets of messages may continue to be exchanged in this manner through the ordering process, the payment process, and the shipping process until at some time the e-commerce transaction is complete (e.g., the first party has the desired goods, and the second party has been paid.)

It should be further noted that for the purposes herein an e-commerce transaction may constitute only an offer to provide certain goods or services, or it may constitute only a request to be provided with certain goods or services. That is, the existence of both an offer and an acceptance is not required for a set of network messages to be considered an e-commerce transaction. Furthermore, the terms of an e-commerce transaction need not specifically include any monetary amount, as an offer or agreement to exchange services and/or goods between two or more parties is also considered for the purposes herein to constitute an e-commerce transaction.

Various methods of conducting business and business models are also made available by the use of the electronic commerce filter in accordance with the teachings of this invention. For example, these teachings provide a method of conducting business over the Internet, wherein parties interact by originating an electronic commerce transaction at a first party and transmitting the electronic commerce transaction through the Internet to a second party. In this embodiment the method includes steps of (a) intercepting the electronic commerce transaction with an electronic commerce transaction filter that is interposed between two data communication network components; and (b) operating the electronic commerce transaction filter in accordance with at least one filter criterion so as to record at least one predetermined type of information. The business method further includes steps of accumulating recorded information from a plurality of electronic commerce transactions, and making the accumulated recorded information available to interested parties.

In another business method the step of accumulating is followed by a step of deriving a new or a modified filtering criterion from the accumulated recorded information, and then offering the new or modified filtering criterion for use by another electronic commerce transaction filter.

In a still further business method, wherein the electronic commerce transaction includes an acceptance of an offer to provide goods or services based on stipulated terms, the method includes steps of intercepting the electronic commerce transaction with an electronic commerce transaction filter that is interposed between two data communication network components; redirecting the intercepted electronic commerce transaction to a third party; and providing the third party the opportunity to provide the goods or services for the stipulated terms.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is a logic diagram depicting a typical sequence of interactions between software components used to carry out an e-commerce transaction;

FIG. 2 shows the logic diagram of FIG. 1 in greater detail;

FIG. 3 shows possible locations for interposing software components (e-commerce transaction filters) for analyzing e-commerce information and possibly taking action based on the processing results;

FIG. 4 depicts an administrative domain that may form a part of the e-commerce network shown in FIG. 3, wherein a plurality of administrative tools are each associated with one of a plurality of e-commerce programs;

FIG. 5 shows a further embodiment of the administrative domain wherein a single administrative tool is associated with a plurality of the e-commerce transaction filters that are located between two layers of the administrative domain, specifically between the e-commerce program layer and the communication layer;

FIG. 6 shows a further embodiment wherein the plurality of e-commerce transaction filters are located between the communication layer and a local network;

FIG. 7 shows a further embodiment wherein a single e-commerce transaction filter is interposed between the local network and an extended network, such as the Internet;

FIG. 8 shows another embodiment wherein the single e-commerce transaction filter is interposed between the local network and a gateway that establishes a secure (encrypted) session path through the extended network;

FIG. 9 shows an embodiment wherein the single e-commerce transaction filter operates on encrypted e-commerce transactions;

FIG. 10 shows an embodiment where a plurality of e-commerce transaction filters are positioned such that they are not required to operated on encrypted e-commerce transactions;

FIG. 11 shows the case of FIG. 9 in greater detail and illustrates the construction of the e-commerce transaction filter that includes cryptographic proxies;

FIG. 12 is a simplified logical block diagram of an e-commerce transaction filter in accordance with the teachings of this invention; and

FIG. 13 illustrates a method in accordance with these teachings.

### DETAILED DESCRIPTION OF THE INVENTION

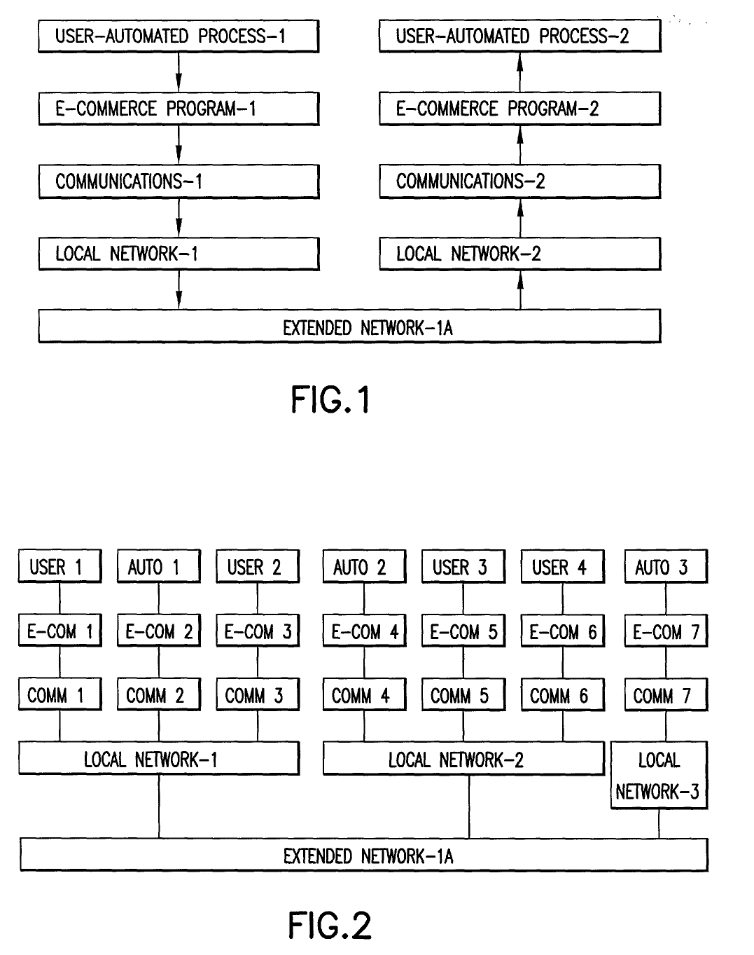

By way of introduction, reference is made to FIG. 1 for illustrating a typical configuration used by e-commerce applications. The implementation does not depend on the number, or on the detailed nature of the components.

A typical e-commerce transaction might involve the illustrated hierarchy of software components. The block labeled User/Automated Process-1 represents a person or computer program that specifies the nature of an e-commerce transaction. Specifying the nature of the transaction could be accomplished in a number of ways, such as by selecting options in a user interface or by programming an automated agent to exercise a programmatic interface. E-commerce program-1 processes this information and places it into a known form. The known form contains data encoded according to some specification such that other programs capable of applying the specification to the known form can meaningfully process the data. There may be more than one specification available and therefore more than one known form used by the e-commerce program. E-commerce program-1 transfers this information to Communications System-1 which in turn sends the information to the communications interface of another e-commerce program. The communications may pass through a Local Network-1 and then over an Extended Network 1A such as the Internet. The information may be transformed several times in transit, such as through a second Local Network-2. The specific details of how the known form is delivered to the Communications System-2 are not important for understanding this example. Communications System-2 delivers the known form to E-commerce program-2, which ultimately interprets the known form. In practice, the activity illustrated in this diagram is repeated many times over, where the e-commerce programs could be provided by many different vendors and be deployed in many different locations. Furthermore, transactions may flow in either direction.

E-commerce programs include web browsers such as Netscape™ and Microsoft's Internet Explorer™, and tools augmented by Java programs, Java scripts and ActiveX™ controls that are programs that web sites provide to the browsers that the browser executes on behalf of the user of the browser. These down-loaded programs are e-commerce specific. There is also a class of emerging e-commerce programs such as IBM's WebSphere™ or Ariba's B2B Commerce Platform™ that may benefit from the teachings of this invention.

FIG. 2 illustrates a more detailed model for the current e-commerce environment, and shows a configuration composed of four distinct users (User-1 through User-4) and three automated e-commerce processes (Auto-i through Auto-3). An example of an automated process is an e-commerce store that supports electronic purchasing. In the example shown in FIG. 2 one can reasonably assume that each e-commerce “stack” or hierarchy employs different e-commerce programs (Ecom-1 through Ecom-7) that may have each been written by a different vendor. For the purpose of illustration, each communications system (Comm-1 through Comm-7) is further assumed to be different from the other communications systems. Assuming that both User-1 and User-2 employ graphical user interfaces to interact with Ecom-1 and Ecom-3, respectively, there is no reason to expect that the user interfaces will be the same or even similar. Analogously, if Auto-1 and Auto-2 are interacting with Ecom-2 and Ecom-4 programmatically, there is no reason to expect the programmatic interfaces to be the same or similar. However, under the conditions specified in the description of FIG. 1, all of the e-commerce programs produce one of the known forms that can be processed by any other e-commerce program that supports the same specification.

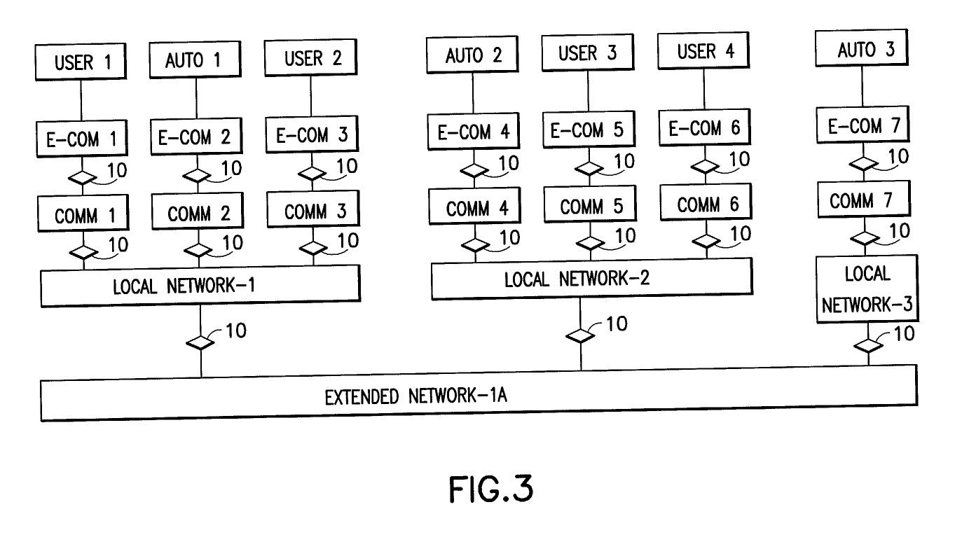

The teachings of this invention provide a technique for interposing software components 10 between one or more of the software components shown in the exemplary e-commerce applications depicted in FIGS. 1 and 2. The interposed software components 10 are placed at a point or points where the e-commerce related data is cast in a known form that enables the interposed software components 10 to interpret all or some of the characteristics of the e-commerce transaction flowing through it between parties. For illustrative purposes, FIG. 3 indicates some of the positions where the interposed software components 10 could be located.

As used herein, the term “interposed” should be interpreted to mean that an e-commerce monitoring subsystem is constructed in whole or in part of a software layer, an object or a component that is inserted between two existing software layers, objects or components such that the pre-existing software layers, objects or components continue to operate properly in the event the subsystem takes no action.

As used herein, “parties” is interpreted to mean any software that represents a person or institution that has the ability to transfer goods, services or money.

As used herein, an “e-commerce transaction” is interpreted to mean any message or collection or set of messages traveling between at least two parties, and that are related to the transfer of goods, services or money.

The interposed software components, hereinafter referred to generically as “e-commerce transaction filters” or simply as “filters” 10, have the ability to analyze the e-commerce traffic passing through them and to possibly take some action based on the results of the analysis. The action can include, but is not limited to, modifying an e-commerce transaction, re-directing an e-commerce transaction, extracting information from an e-commerce transaction for recording the information for statistical or other purposes, verifying the authenticity of an e-commerce transaction, verifying the authenticity of some component of an e-commerce transaction, such as an electronic signature, and/or verifying that the e-commerce transaction is in compliance with some regulation or standard. Alternatively, the e-commerce transaction may be simply passed transparently through a filter 10 without modification and without recording any information regarding the e-commerce transaction. These various actions and others will be discussed in greater detail below.

It should be noted that while the presence of publicly available standards would be beneficial, all that is necessary for implementing this invention is access to the various interface specification(s), however obtained.

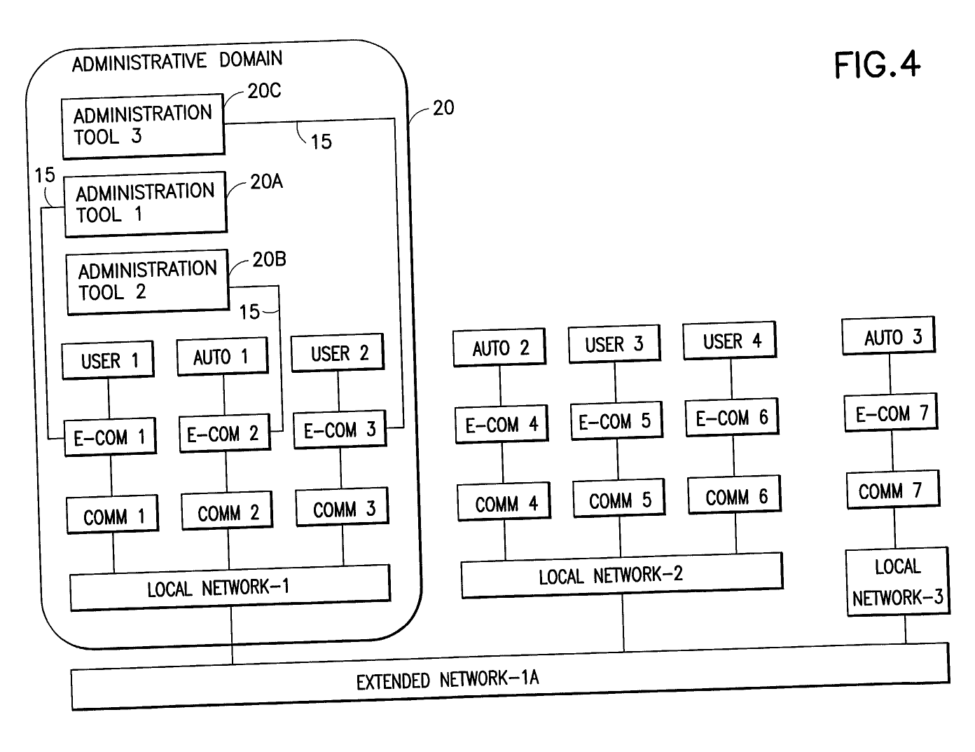

Although a number of different types of analysis of the e-commerce transactions may be performed, in a presently preferred, but non-limiting embodiment, the analyses fall into two categories: (a) analysis for the purpose of collecting information across an administrative domain and (b) analysis pursuant to enforcing a policy for an administrative domain. An administrative domain (see FIGS. 4-11) may be a single machine, a single user who could appear on different machines, a collection of users or machines, or any combination thereof. The policy that is enforced may be a governmental policy or regulation or standard, or it may be some other type of public policy or regulation or standard, or it may be a private policy or regulation or standard.

While the filters 10 may appear at different levels of the communications hierarchy, they have the potential for extracting equivalent information. For example, a filter 10 interposed between Ecom-1 and Comm-1 may, in this example, perform the same analysis as a filter 10 interposed between Comm-1 and the Local Network-1.

With regard to policy administration, and referring as well to FIG. 4, policy and the collection of e-commerce transaction information may be enabled within either the User/Automated Process components or within the e-commerce programs themselves (Ecom-1 through Ecom-7). In order to collect equivalent data or enforce uniform policies across a single administrative domain 20, a single administrative program that provides the equivalent administrative capabilities for software from different e-commerce software vendors can be used, or one may perform administrative functions with three different administration programs 20A, 20B and 20C for the three different e-commerce programs (Ecom-1 through Ecom-3). The latter case is specifically illustrated in FIG. 4.

Consider first the case where administrative capabilities do exist in the User/Automated Process components (User-1, User-2, Auto-1) or in the e-commerce programs (Ecom-1 through Ecom-3). In a multi-product environment, those capabilities can only provide consistent coverage across the administrative domain 20 when each product supports similar administrative capabilities. In the general case, in which the administrative domain 20 contains different e-commerce software products (perhaps from different vendors), administrative capabilities are specific to each product or vendor, and do not enable uniform capabilities across the administrative domain 20. Of course, even if similar administrative capabilities are available for all e-commerce software products, it may not be practical to apply a uniform policy across all of the e-commerce programs. For example, the desired policy may be to enforce limits for certain operations within the administrative domain 20 (e.g., the total amount of money spent). In the embodiment illustrated in FIG. 4, this would be difficult or impractical since the administrative tool programs 20A-20C do not share information. As a result, no single one of the three administrative tool programs 20A-20C has an overall view of the administrative domain 20.

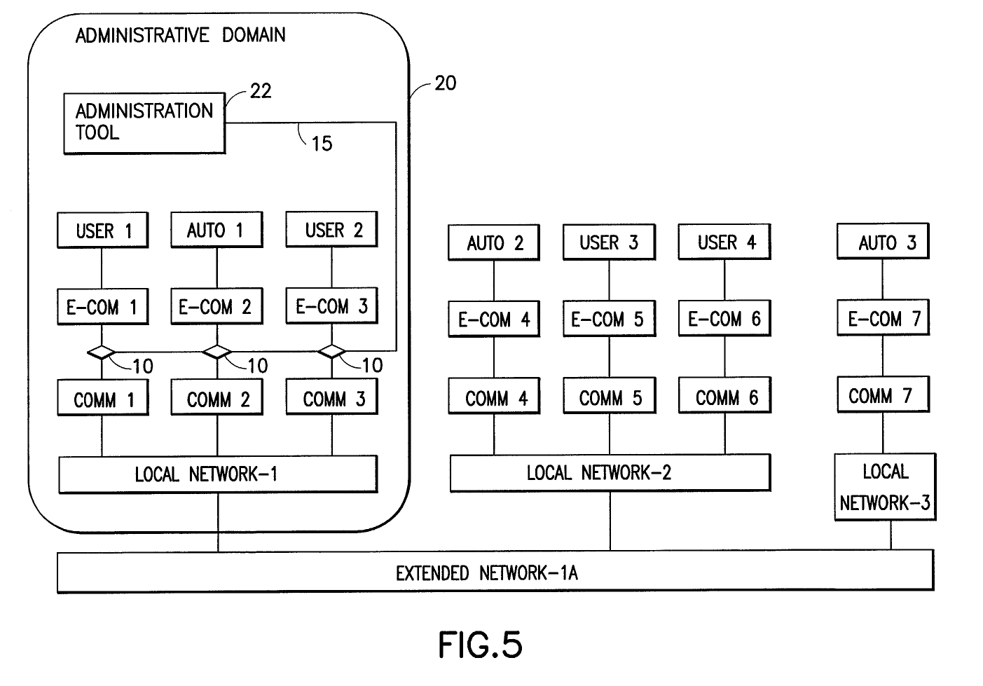

Referring now to FIG. 5, in accordance with an aspect of this invention, more comprehensive and uniform coverage across the administrative domain 20 is achieved by adding an e-commerce based filter 10 across a layer of the e-commerce stack or hierarchy within the administrative domain 20. In the illustrated embodiment three filters 10 are added, one between Ecom-1 and Comm-1, one between Ecom-2 and Comm-2 and one between Ecom-3 and Comm-3. Each of the filters 10 is coupled over a physical or a logical data path 15 to a single administrative tool 22, and feeds filtered e-commerce transaction information to the single administrative tool 22.

The known form of the e-commerce related information allows it to be analyzed independent of the particular e-commerce program from which it originates. In cases where e-commerce transaction information is being collected or accumulated, the information can be accumulated based on the known form of the e-commerce transaction data, thereby enabling traffic originating from different e-commerce programs to be combined. Similarly, enforcement of policies specifiable at the e-commerce transaction level can be evaluated seamlessly across different e-commerce software products, even those originating from different e-commerce software vendors.

FIG. 5 illustrates but one suitable embodiment for interposing the e-commerce based filters 10 uniformly across a heterogeneous administrative domain 20.

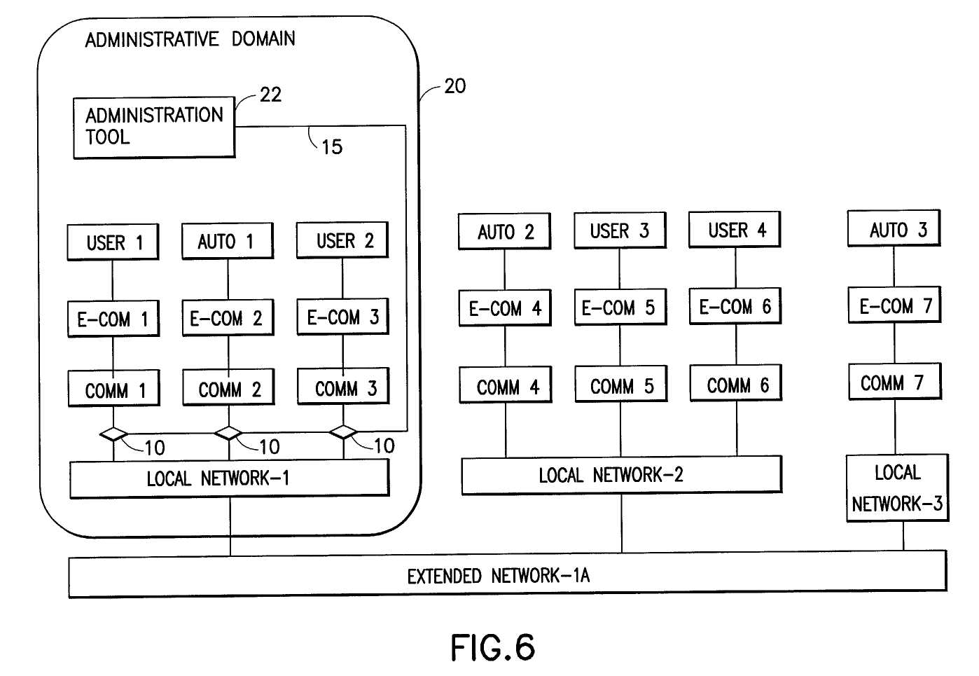

For example, FIG. 6 illustrates a further embodiment in which e-commerce-based filtering is accomplished by placing individual ones of the three filters 10 between Comm-1, Comm-2 and Comm-3 and the Local Network-1. As in FIG. 5, each of the filters 10 is coupled to the single administrative tool 22 over the data path 15, and feed selectively filtered e-commerce transaction information to the single administrative tool 22.

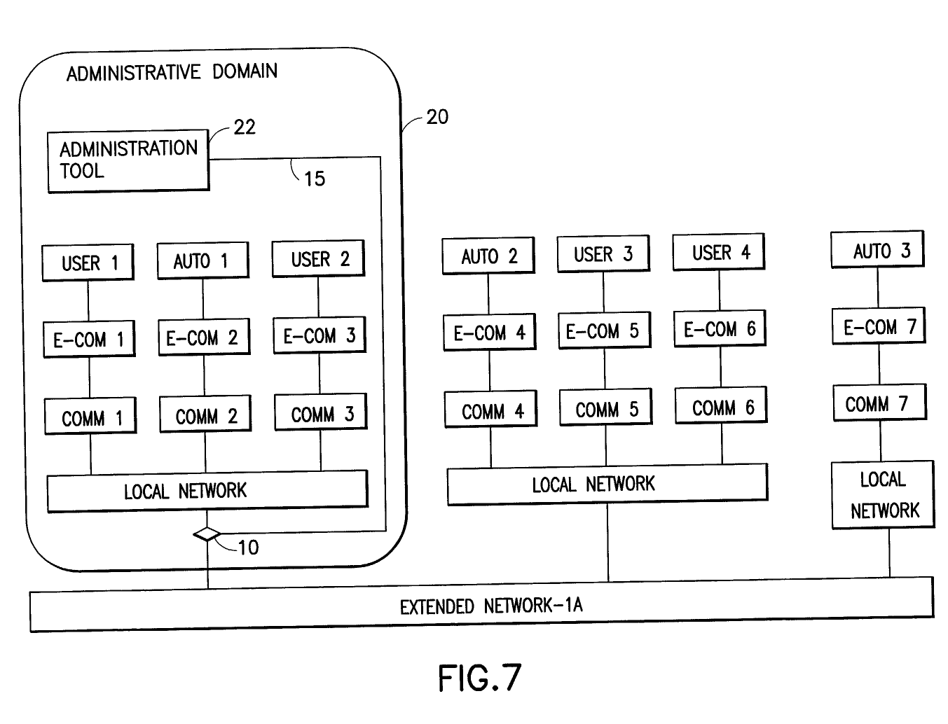

FIG. 7 illustrates a still further embodiment of these teachings, wherein the e-commerce based filtering is carried out at the interface between the Local Network-1 and the Extended Network 1A. In this case a single e-commerce filter 10 is coupled to the single administrative tool 22 over the data path 15, and feeds filtered e-commerce transaction information to the single administrative tool 22.

A discussion will now be made of the impact of cryptographic technologies on the teachings of this invention.

Cryptographic technologies are widely employed in e-commerce transactions for identifying the source of messages, verifying their authenticity and hiding their content from unauthorized persons or programs. In certain system configurations the presence of cryptographic technologies impedes the ability of the filter(s) 10 to analyze or modify data in the known form. However, there are many system configurations that provide cryptographic protections without preventing the proper operation of the filters 10.

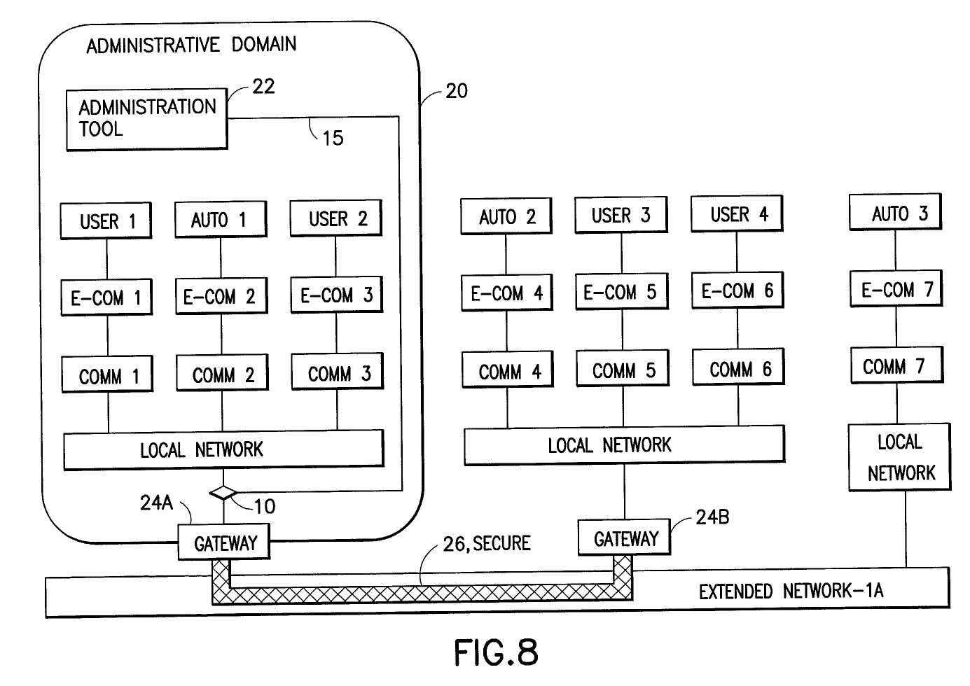

As an example, FIG. 8 (which uses for convenience the same exemplary network architecture as in FIGS. 2-7) illustrates a system configuration in which cryptographic techniques are used to provide a secure and private data path, session or “tunnel” 26 through an insecure public network, in this case the Extended Network 1A. As was stated previously, the Extended Network 1A could include the Internet. In this embodiment the secure tunnel 26 is made between two network gateways 24A and 24B connected to Local Network-1 and Local Network-2, respectively. In this embodiment the operation of the filter 10, positioned as in the embodiment of FIG. 7, is not limited by the encryption used by the gateways 24A and 24B to construct and maintain the secure private tunnel 26. The same applies when the filters 10 are located higher in the e-commerce hierarchy, as in the embodiments illustrated in FIGS. 5 and 6.

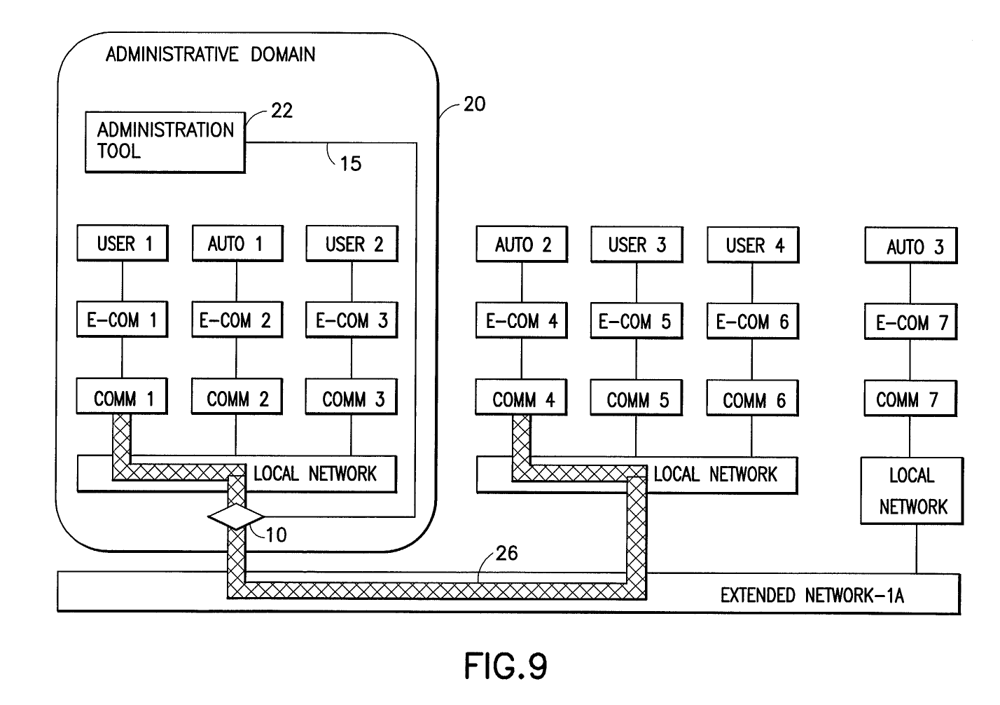

In those types of systems wherein data encryption is introduced in the communications component (e.g., at the Comm-n level), a filter 10 located at a gateway 24 (as shown in FIG. 8) may not be capable of meaningfully processing the known form of an e-commerce transaction. In order to meaningfully process encrypted data, the filter 10 would require access to the decryption key, which is contrary to most security policies. This situation is illustrated in FIG. 9, wherein the encryption is performed within the communication layer.

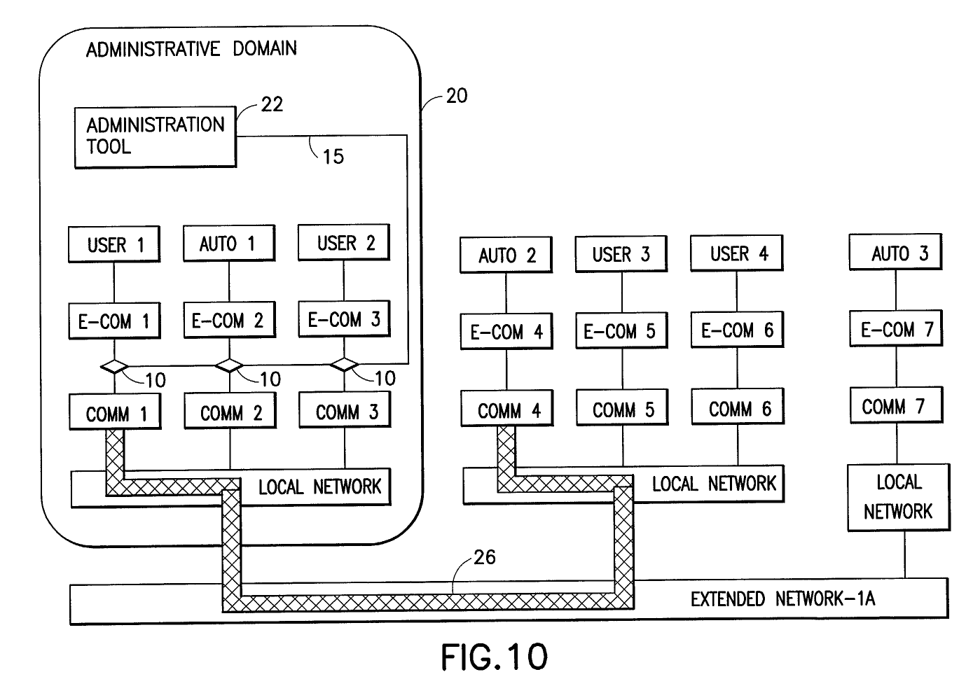

One technique to avoid the situation illustrated in FIG. 9 is to position the filters 10 at the e-commerce program/communications component boundary as is illustrated in FIG. 10. The embodiment illustrated in FIG. 10 has the advantage of working seamlessly with many forms of session layer cryptography, such as Secure Sockets Layer (SSL) services. SSL is a well-known method for including encryption and authentication into e-commerce systems. Since the filters 10 are positioned before the encryption/decryption function performed in the communication layer (Comm-1 in this example), the filters are enabled to operate on e-commerce transactional data “in the clear”.

E-commerce transactions may flow through a wide variety of cryptographic technologies. As such, the e-commerce based filters 10 preferably have strategies for operating in the presence of a variety of cryptographic technologies. Such strategies include, but are not limited to, the following several strategies.

(A) The e-commerce filter 10 may be interposed above the components that implement the cryptographic technology. FIGS. 8 and 10 illustrate this approach, which is appropriate when the system administrator has flexibility in choosing where to interpose the filter(s) 10.

(B) The e-commerce filter 10 may be provided the keys necessary to encrypt and decrypt the messages flowing through it. FIG. 9 illustrates this approach, which is appropriate when the filter 10 has access to the key(s) necessary to decrypt the e-commerce data stream.

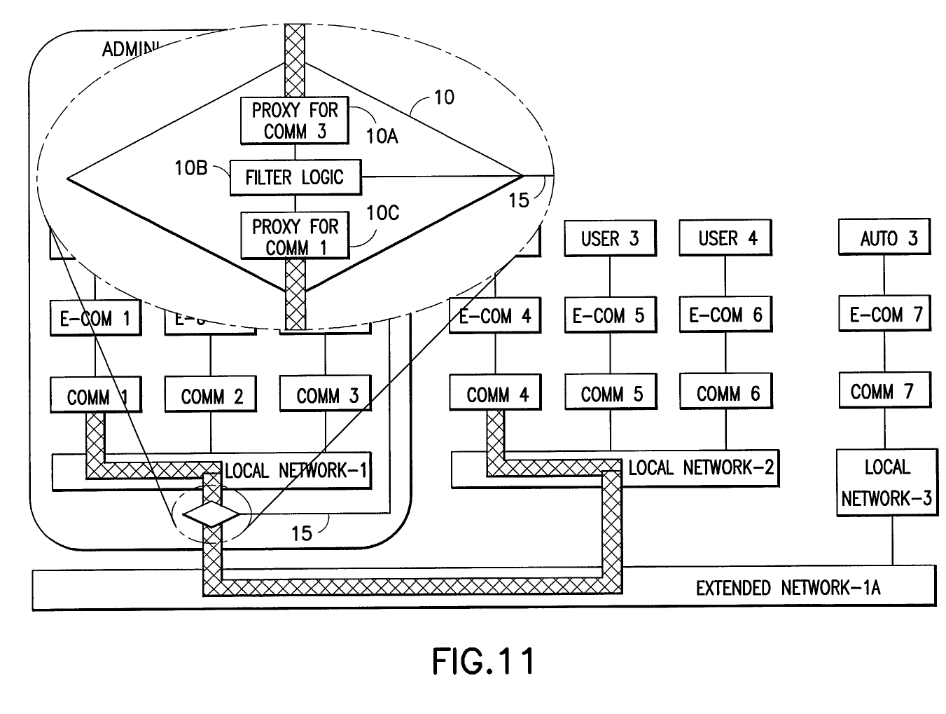

(C) The e-commerce filter 10 may include two cryptographic proxies, paired with the communications programs at each end of a secure “session”. Each proxy connects to one of the communications programs and plays the role of the other communications program in the cryptographic protocols they use, thus forming two separate secure “sessions” with the filter logic between them. FIG. 11 illustrates this approach, which is appropriate when asymmetric-key (also known as public-key) cryptographic technologies are used. In FIG. 11 the e-commerce filter 10 can be seen to include filter logic 10B which is interposed between two cryptographic proxies 10A and 10C, one for Comm-4 and one for Comm-1.

(D) In a further strategy for successfully operating in the presence of a variety of cryptographic technologies, the e-commerce filter 10 may be given a key that can be used to decrypt only a part of the message, as when the communications are encrypted with multiple keys, and where only one of the keys is provided to the filter 10. FIG. 9 can be used to illustrate this approach.

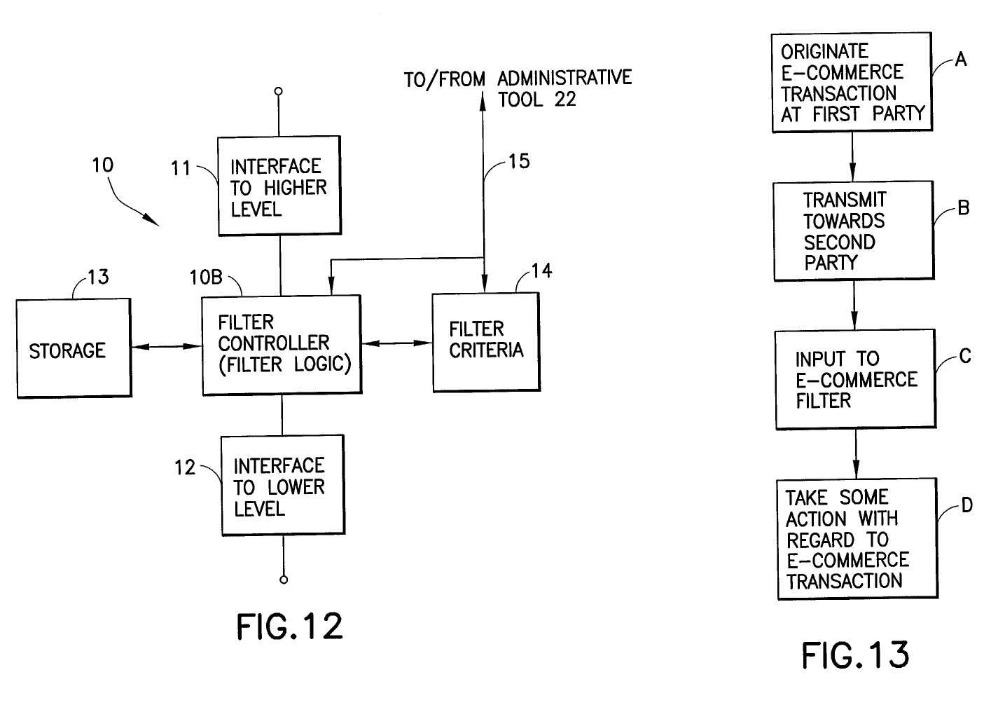

FIG. 12 depicts a logical block diagram of the e-commerce filter 10. It should be realized that the functionality of the filter 10 may be implemented entirely by software, entirely by hardware, or by a combination of software and hardware. The filter 10 includes the above-mentioned filter logic 10B that can be implemented with a suitably programmed data processor, such as microprocessor. The filter logic 10B is connected between a first interface 11 to a higher level of the e-commerce stack or hierarchy and by a second interface 12 to a lower level of the e-commerce stack or hierarchy. For the embodiments shown in FIGS. 7, 9 and 11 the second interface 12 is to the Extended Network 1A, while in the embodiment shown in FIG. 8 the second interface 12 is to the gateway 24. E-commerce transaction messages and packets arrive at one of the first or second interfaces 11 and 12, and are transmitted after analysis and possible modification (unless blocked) from the other interface. The filter 10 includes storage, preferably the persistent storage 13 for maintaining any required operating parameters, executable code for the filter logic 10B, cryptographic key(s) (if complete or partial decryption is performed in the filter module 10), as well as temporarily storing, as discussed below, portions of one e-commerce transaction that may be distributed over a plurality of sub-transactions. The filter 10 also includes a filter criteria module 14 that may also be implemented as persistent storage. The filter criteria module is coupled over data path 15 to the administrative tool 22 and may receive new or updated criteria to apply when analyzing e-commerce transactions passing through the filter 10. These filter criteria can encompass any relevant information to be applied by the filter logic 10B when examining and analyzing e-commerce transactions, including, but not limited to, relevant standards and/or statutes, identifications of types of e-commerce transactions on which statistics are to be recorded (e.g., types and/or numbers of goods or services transacted for, dollar amounts, sales tax-related information, credit card information, etc.), as well as profiles of known types of fraudulent e-commerce transactions, as will be discussed in further detail below. The filter logic 10B is also coupled to the administrative tool 22 through the data path 15, and thereby is enabled to provide the results of its e-commerce transaction analysis to the administrative tool 22.

As was mentioned, the e-commerce filter 10 may be programmed to reconstruct an e-commerce transaction even if the transaction is partitioned into multiple sub-transactions. This can be accomplished by providing the persistent storage 13 (see FIG. 12) in the filter 10 for aiding in associating the appropriate portions of one e-commerce transaction in order to build a complete picture of the transaction. Using such technology, the filter 10 can potentially determine the identities of the transaction parties, timings, and specific details such as quantities and part numbers. It is also within the scope of these teachings to, in some cases, modify an e-commerce transaction with the filter 10 so as to create new functionality in the system or to enforce specific policies from within the filter(s) 10.

There are a plurality of fundamental classes of activity that are enabled by the use of the teachings of this invention. The classes of activity include, but are not limited to, the following: (a) rerouting e-commerce transactions, which may include automated bundling as well as offering a transaction to a third party; (b) modifying e-commerce transactions, that can include blocking e-commerce transactions, stalling e-commerce transactions, and alerting on selected e-commerce transactions or situations; (c) recording e-commerce transactions; and (d) generating new e-commerce transactions, which can include ordering related goods and ordering related services.

Based on the foregoing discussion of the presently preferred embodiments of these teachings it should be appreciated that the use of the teachings of this invention provide the opportunity to implement various types of business models. These include, but are not limited to, the following.

In one embodiment the use of the filter(s) 10 enables one to collect information from subscribers in a way that appropriately protects the customer's privacy, as well as to centrally analyze the data in order to detect unacceptable transactions and, in response, possibly in real time, to distribute identification information to subscriber filters 10 that can block or stall detected unaccepted transactions. This identification can be stored in, for example, the filter criteria module 14 (see FIG. 12) which is assumed to be a persistent storage device. This is an advance over existing systems involving the distribution of updates to other types of filtering systems, as it extends the updating of filtering systems into electronic commerce. As an example of updating another type of filtering system reference can be had to “Blueprint for a Computer Immune System”, Jeffery O. Kephart, Gregory B. Sorkin, Morton Swimmer and Steve R. White, Proceedings of the 1997 International Virus Bulletin Conference, San Francisco, Calif., October 1-3, 1997.

In another embodiment one is enabled to construct a security team that is responsible for staying current on current Internet-based scams and fraud. The security team learns how to identify a fraudulent e-commerce transaction by analyzing the transactions that are used to carry out the fraud. The identification technology may then be supplied to subscribers as updates to their filter criteria modules 14. When a filter 10 running at a customer site identifies a fraud-related transaction the security team may provide value added services, such as obtaining legally relevant information for future prosecution. The security team could be an in-house security team, or a security team whose services are offered by a security service organization or company, possibly for a fee.

In another embodiment the teachings of this invention enable a third party transaction recording company to be implemented. The transaction record repository company installs filters 10 across a subscriber's organization in order to collect a record of the transactions undertaken by the organization. These filters 10 encrypt the transaction information and send it to the third party repository. The repository time stamps the transaction history and archives it for a period of time. However, absent the relevant cryptographic key(s), the repository company would not be able to interpret the encrypted data.

Further in this regard, the invention enables a third party transaction recording company to solve a well-known conflict between privacy and non-repudiation. The recording company's e-commerce filters 10, installed across a subscriber company's organization, may use the public key (b) of a public/private key pair (a,b), chosen by the subscriber company, to encrypt transaction information before sending it to the recording company for time-stamping and archiving. The subscriber company may discard, or claim to have discarded, the private key (a) so that data archived by the recording company cannot be decrypted by them, or by anyone else who obtains the archived data. In spite of this, the subscriber company, or its trading partner, can later prove that a particular transaction was executed. This is accomplished by recovering the unencrypted information for the particular transaction from their internal logs, and then showing that when this information is encrypted with the public key (b), that it matches the data archived by the recording company. This is advantageous to the subscriber company because it can employ the recording company to prevent repudiation of its e-commerce transactions without compromising the privacy of the e-commerce transaction information. This is also advantageous to the recording company, as it cannot be compelled to release its subscribers' information, for example, to a government agency.

In a further related aspect to this embodiment, the subscriber organization could encrypt with a symmetric key and hold the key so only the holder of the key would be able to decrypt the data in the archive.

In another embodiment the teachings of this invention enable one to offer as a subscription service various filter-based heuristics for detecting potential e-commerce fraud. The power of the filter-based heuristics would be greater than those heuristics implemented within a single e-commerce software product, since they would embody information derived from an entire administrative domain, and possibly over a variety of e-commerce products.

In another embodiment one would be enabled to offer a subscription service that remains current with changing regulations, such as export laws, tax laws and the like, and to provide this information as intelligence in filters 10 that monitor/enforce compliance with relevant regulations.

In yet another embodiment a third party vendor provides filters 10 to a customer. After installing the filters 10, the customer searches for the best deal available for desired goods or services, and then executes a purchase transaction. The filter 10 intercepts the purchase transaction and offers the third party vendor via a message, e-mail or another e-commerce transaction the opportunity to supply the goods or services at a price that is appropriately related to the discovered price. For example, the third party vendor may provide the service or goods at the discovered price, or it may offer a discount over the discovered price, or the third party vendor may even apply a surcharge over the discovered price (in exchange for some other service that it performs.) In any case, the third party vendor is enabled to re-direct the purchase order from the original seller of the goods or services to itself There could be a variety of incentives provided to the customer by the third party vendor in order to obtain the business, such as an overall discount provided to the company at the end of the year based on the total amount of business transacted.

In another embodiment a service is provided to audit the policies of the filter(s) and to certify them as in compliance with some standard, or consistent with best practices, or in agreement with some other relevant criteria.

In yet another business method that is made possible by the use of the teachings of this invention, a subscription service provides additional security checks before a transaction can be completed. For example, the subscription service operates to extend the certification/authentication function commonly present in e-commerce applications to include enforcing additional policy relative to signatures; e.g., that a person is authorized to sign in a specific role (purchaser, co-signer); or cross-checking information held at different sites; e.g., multiple banks may have to assure payment when the funds covering a transaction are spread across different accounts.

The foregoing business methods are not intended to be exhaustive, but merely exemplary of the number of possible uses of the e-commerce transaction filters 10 in accordance with these teachings.

The teachings herein thus provide in one aspect for a software and/or hardware subsystem to be interposed between two or more parties, where the subsystem intercepts at least one e-commerce transaction and takes some action based upon properties of the e-commerce transaction. The presence of the subsystem does not require any changes to the protocols used by the parties., i.e., it is transparent to the parties involved. The subsystem includes one or more components that identify e-commerce transaction-related traffic, even when other traffic is passing between the parties. The subsystem that is interposed between the two or more parties may include one or more software components that deduce what, if any, action should be taken in connection with an e-commerce transaction arriving at the subsystem. The action may be deduced in part or in whole by applying predefined rules to the contents of one or more messages that comprise an e-commerce transaction, or by applying predefined rules that are independent of the contents of any messages that comprise an e-commerce transaction, by applying predefined rules based entirely on the origin or destination of one or more messages that comprise an e-commerce transaction. In a further embodiment the action is deduced by supplying information to another software subsystem and receiving a reply. The action may also be deduced by interacting with a human operator.

The subsystem, i.e., the transparent e-commerce filter 10, that is interposed between the two or more parties may include a software component that modifies an e-commerce transaction arriving at the subsystem before it is passed to the intended party, or that blocks a received message to the intended party, or that passes a received message, with or without modification, to a different party than the intended party.

Referring now to FIG. 13, a method in accordance with these teachings includes steps of: (A) originating an electronic commerce transaction at a first party, (B) transmitting the electronic commerce transaction through the data communications network towards a second party, and during the step of transmitting, (C) inputting the electronic commerce transaction to an electronic commerce transaction filter that is interposed between two network components. The filter operates so as to take some action (D) with respect to the electronic commerce transaction. The action could include modification, redirection and/or one or more of the actions described above. The action could also include simply passing the e-commerce transaction through the electronic commerce transaction filter. Preferably the electronic commerce transaction filter acts transparently with respect to all system and network nodes, layers and parties.

It should be appreciated that the method shown in FIG. 13, and as described in detail above, may be embodied as computer program instructions recorded onto a computer-readable medium, such as a removable or fixed disk, a tape, or a semiconductor memory.

While the invention has been particularly shown and described with respect to preferred embodiments thereof, it will be understood by those skilled in the art that changes in form and details may be made therein without departing from the scope and spirit of the invention.

What is claimed is:

1. A method for operating a data communication system, comprising steps of:
originating an electronic commerce transaction at a first party;
transmitting the electronic commerce transaction through the data communications network towards a second party;
during the step of transmitting, inputting the electronic commerce transaction to an electronic commerce transaction filter that is interposed between two network components; and
operating the electronic commerce transaction filter to take some action with respect to the electronic commerce transaction.

2. A method as in claim 1, wherein the action taken with respect to the electronic commerce transaction is an analysis of the electronic commerce transaction for the purpose of collecting information across an administrative domain.

3. A method as in claim 1, wherein the action taken with respect to the electronic commerce transaction is an analysis of the electronic commerce transaction for the purpose of enforcing a policy for an administrative domain.

4. A method as in claim 1, wherein the action taken with respect to the electronic commerce transaction is a modification of the electronic commerce transaction.

5. A method as in claim 1, wherein the action taken with respect to the electronic commerce transaction is a redirection of the electronic commerce transaction to a third party.

6. A method as in claim 1, wherein the action taken with respect to the electronic commerce transaction is an extraction of information from the e-commerce transaction for recording the information for statistical or other purposes.

7. A method as in claim 1, wherein the action taken with respect to the electronic commerce transaction is a verification of the authenticity of the electronic commerce transaction.

8. A method as in claim 1, wherein the action taken with respect to the electronic commerce transaction is a verification of the authenticity of a component part of the electronic commerce transaction.

9. A method as in claim 1, wherein the action taken with respect to the electronic commerce transaction is a verification that the electronic commerce transaction is in compliance with a regulation.

10. A method as in claim 1, wherein the action taken with respect to the electronic commerce transaction is a verification that the electronic commerce transaction is in compliance with a standard.

11. A method as in claim 1, wherein the action taken with respect to the electronic commerce transaction is a termination of the electronic commerce transaction.

12. A method as in claim 1, wherein the action taken with respect to the electronic commerce transaction is a delay of the electronic commerce transaction.

13. A method as in claim 1, wherein the action taken with respect to the electronic commerce transaction is an encryption of all or a part of the electronic commerce transaction, and sending the encrypted electronic commerce transaction to another destination.

14. A method as in claim 1, wherein the action taken with respect to the electronic commerce transaction is generating an alert if an analysis performed by the electronic commerce transaction filter indicates that a certain filtering criterion is met.

15. A method as in claim 1, wherein the action taken with respect to the electronic commerce transaction is passing the electronic commerce transaction through the electronic commerce transaction filter without modification and without recording any information regarding the electronic commerce transaction.

16. A method as in claim 1, wherein the action taken with respect to the electronic commerce transaction is selected at least in part by applying predefined rules to the contents of one or more messages that comprise the electronic commerce transaction.

17. A method as in claim 1, wherein the action taken with respect to the electronic commerce transaction is selected at least in part by applying predefined rules that are independent of the contents of one or more messages that comprise the electronic commerce transaction.

18. A method as in claim 1, wherein the action taken with respect to the electronic commerce transaction is selected at least in part by applying predefined rules based on at least one of an origin or a destination of the electronic commerce transaction.

19. A method as in claim 1, wherein the action taken with respect to the electronic commerce transaction is recording at least one predetermined type of information, and further comprising steps of accumulating recorded information from a plurality of electronic commerce transactions, and making the accumulated recorded information available to interested parties.

20. A method as in claim 1, wherein the action taken with respect to the electronic commerce transaction is recording at least one predetermined type of information, and further comprising steps of accumulating recorded information from a plurality of electronic commerce transactions, and deriving a filtering criterion from the accumulated recorded information for use in the same or in another electronic commerce transaction filter.

21. A method as in claim 1, wherein the step of operating is performed in parallel in a plurality of electronic commerce transaction filters that are disposed between two layers of an administrative domain hierarchy.

22. A method as in claim 1, wherein the step of operating comprises an initial step of decrypting all or part of the electronic commerce transaction.

23. A method as in claim 1, wherein the action taken with respect to the electronic commerce transaction is an encryption of all or a part of the electronic commerce transaction using at least one cryptographic key, and further comprising a step of sending the at least one cryptographic key to another location.

24. A method as in claim 1, wherein the action taken with respect to the electronic commerce transaction is a verification that the electronic commerce transaction is in compliance with a predetermined policy.

25. A method as in claim 1, wherein the action taken with respect to the electronic commerce transaction is determining whether the electronic commerce transaction may be fraudulent.

26. A data communication system, comprising:
a first party for originating an electronic commerce transaction and for transmitting the electronic commerce transaction through a data communications network towards a second party; and
an electronic commerce transaction filter that is transparently interposed between two data communication network components, said filter operating on the electronic commerce transaction in accordance with at least one filter criterion for taking some action with respect to the electronic commerce transaction.

27. A method of conducting business over the Internet, wherein parties interact by originating an electronic commerce transaction at a first party and transmitting the electronic commerce transaction through the Internet to a second party, the method comprising steps of:
intercepting the electronic commerce transaction with an electronic commerce transaction filter that is interposed between two data communication network components; and
operating the electronic commerce transaction filter in accordance with at least one filter criterion so as to record at least one predetermined type of information, and further comprising steps of accumulating recorded information from a plurality of electronic commerce transactions, and making the accumulated recorded information available to interested parties.

28. A method of conducting business over the Internet, wherein parties interact by originating an electronic commerce transaction at a first party and transmitting the electronic commerce transaction through the Internet to a second party, the method comprising steps of:
intercepting the electronic commerce transaction with an electronic commerce transaction filter that is interposed between two data communication network components; and
operating the electronic commerce transaction filter in accordance with at least one filter criterion to record at least one predetermined type of information, and further comprising steps of accumulating recorded information from a plurality of electronic commerce transactions, deriving a new or a modified filtering criterion from the accumulated recorded information, and further comprising a step of offering the new or modified filtering criterion for use by another electronic commerce transaction filter.

29. A method of conducting business over the Internet, wherein parties interact by originating an electronic commerce transaction at a first party and transmitting the electronic commerce transaction through the Internet to a second party, where the electronic commerce transaction comprises an acceptance of an offer to provide goods or services based on stipulated terms; the method comprising steps of:
intercepting the electronic commerce transaction with an electronic commerce transaction filter that is interposed between two data communication network components;
redirecting the intercepted electronic commerce transaction to a third party; and
providing the third party the opportunity to provide the goods or services for the stipulated terms or for other terms related to the stipulated terms.

30. A method as in claim 29, wherein the step of providing enables the third party to provide the goods or services for a price that is either less than or greater than a price set by the stipulated terms.

31. A computer-readable medium comprising computer program instructions for directing a computer to execute a method having steps of, in response to originating an electronic commerce transaction at a first party and transmitting the electronic commerce transaction through a data communications network towards a second party, inputting the electronic commerce transaction to an electronic commerce transaction filter that is transparently interposed between two network components; and operating the electronic commerce transaction filter to take some action with respect to the electronic commerce transaction in accordance with at least one filter criterion.
